(19) United States
(12) Patent Application Publication
(10) Pub. No.: US 2022/0407706 A1
(43) Pub. Date: Dec. 22, 2022

(54) GENERATION DEVICE, GENERATION METHOD, AND VERIFICATION DEVICE

(71) Applicant: SONY GROUP CORPORATION, TOKYO (JP)

(72) Inventors: ATSUSHI UCHIDA, TOKYO (JP); SHINYA MARUYAMA, TOKYO (JP)

(21) Appl. No.: 17/755,305

(22) PCT Filed: Oct. 29, 2020
(86) PCT No.: PCT/JP2020/040724

§ 371 Date: Apr. 26, 2022

(30) Foreign Application Priority Data
Nov. 5, 2019 (JP) 2019-201024

(51) Int. Cl. H04L 9/32

(52) U.S. Cl. CPC H04L 9/3221

(57) ABSTRACT

The generation device (20) is a generation device for generating certification information used for verification using zero-knowledge proof, and includes a conditional expression generation unit (23a) and a certification information generation unit (23b). The conditional expression generation unit (23a) generates, for different conditions, a plurality of conditional expressions that defines confidential information under one or more conditions. The certification information generation unit (23b) generates, as the certification information, a plurality of proofs based on each of the conditional expressions.

### FIELD

The present disclosure relates to a generation device, a generation method, and a verification device.

### BACKGROUND

There has been proposed an attempt to protect privacy and provide convenience in the case of authentication processing such as identity verification processing to receive service on the Internet using personal information such as the name, address, telephone number, and email address of a user.

In light of the privacy protection, in the authentication processing such as the identity verification processing, the use of a zero-knowledge proof method may be considered in which a user does not need to present information that the user would not like to reveal, such as the personal information.

### CITATION LIST

### Patent Literature

Patent Literature 1: JP 2019-40537 A

### SUMMARY

### Technical Problem

The use of the zero-knowledge proof method involves a problem in that a processing load associated with change of certification information for certifying that personal information is known is large due to the complexity of conditions for defining the personal information.

To address this, the present disclosure proposes a generation device, a generation method, and a verification device that can reduce the processing load associated with the change of the certification information.

### Solution to Problem

To solve the above problem, a generation device that provides a service that requires an identity verification process according to an embodiment of the present disclosure includes: a conditional expression generation unit that generates, for different conditions, a plurality of conditional expressions that define confidential information under one or more conditions; and a certification information generation unit that generates, as the certification information, a plurality of proofs based on each of the conditional expressions.

### BRIEF DESCRIPTION OF DRAWINGS

FIG. 1 is a diagram schematically illustrating an example of a system configuration of an information processing system according to an embodiment.

FIG. 2 is a diagram illustrating an outline of an information processing system according to an embodiment.

FIG. 3 is a diagram illustrating an example of a generation method of certification information according to a comparative example.

FIG. 4 is a block diagram illustrating an example of the functional configuration of a user terminal according to an embodiment.

FIG. 5 is a block diagram illustrating an example of the functional configuration of an information bank device according to an embodiment.

FIG. 6 is a diagram illustrating an outline of information stored in a personal information storage unit according to an embodiment.

FIG. 7 is a diagram illustrating an outline of information stored in a certification information storage unit according to an embodiment.

FIG. 8 is a diagram illustrating an outline of setup processing according to an embodiment.

FIG. 9 is a diagram illustrating an outline of setup processing according to an embodiment.

FIG. 10 is a diagram illustrating an outline of setup processing according to an embodiment.

FIG. 11 is a diagram illustrating an outline of a generation method of certification information according to an embodiment.

FIG. 12 is a diagram illustrating an outline of a generation method of certification information according to an embodiment.

FIG. 13 is a diagram illustrating an outline of a generation method of certification information according to an embodiment.

FIG. 14 is a diagram illustrating an outline of an updating method of certification information according to an embodiment.

FIG. 15 is a diagram illustrating an outline of an updating method of certification information according to an embodiment.

FIG. 16 is a block diagram illustrating an example of the functional configuration of an information user device according to an embodiment.

FIG. 17 is a diagram illustrating an outline of verification processing according to an embodiment.

FIG. 18 is a sequence diagram illustrating an example of processing steps by an information processing system according to an embodiment.

FIG. 19 is a sequence diagram illustrating an example of processing steps by an information processing system according to an embodiment.

FIG. 20 is a sequence diagram illustrating an example of processing steps by an information processing system according to an embodiment.

FIG. 21 is a sequence diagram illustrating an example of processing steps by an information processing system according to an embodiment.

FIG. 22 is a diagram illustrating an outline of a conditional expression according to a modification example.

FIG. 23 is a hardware configuration diagram illustrating an example of a computer that implements functions of an information bank device.

### DESCRIPTION OF EMBODIMENTS

Hereinafter, embodiments of the present disclosure are described in detail with reference to the drawings. In the following embodiments, the same parts are denoted with the same reference numerals and repeated explanation of these parts is omitted in some cases.

Further, the present disclosure is described in the following order of items.

1. System configuration example

2. Functional configuration example

3. Example of processing steps

4. Modification example

5. Other

6. Summary

7. Hardware configuration

### 1. System Configuration Example

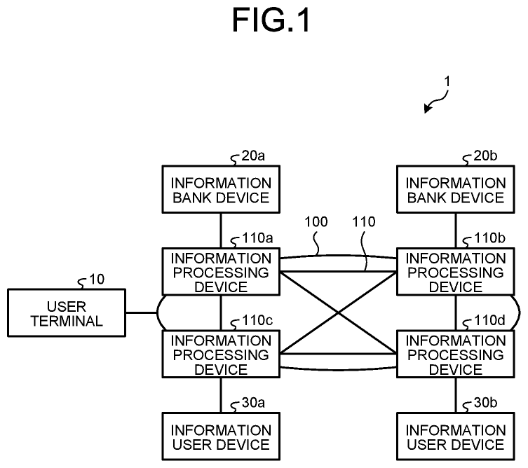

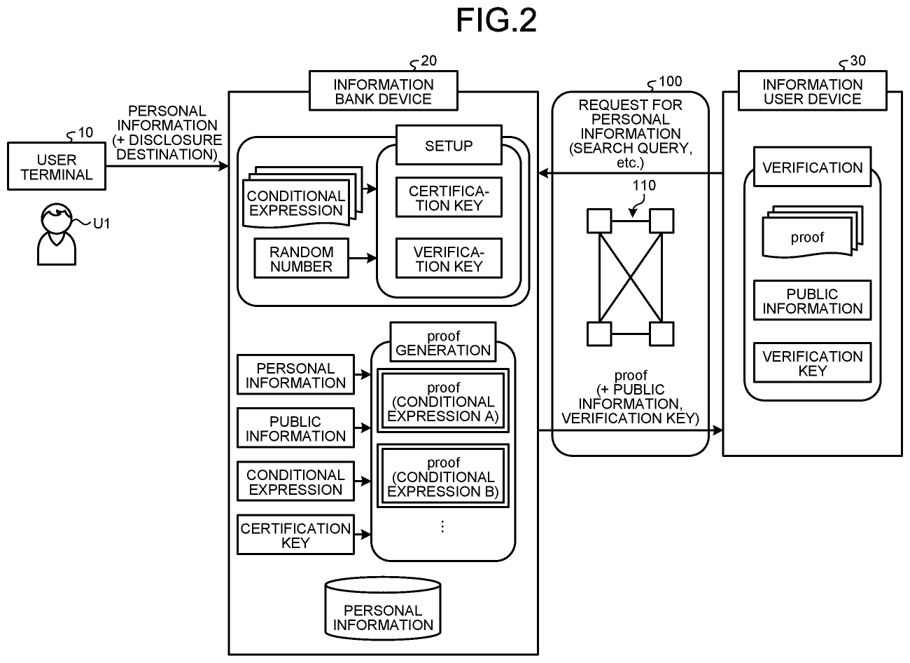

An example of the system configuration of an information processing system according to an embodiment is described with reference to FIGS. 1 and 2. FIG. 1 is a diagram schematically illustrating an example of a system configuration of an information processing system according to the embodiment. FIG. 2 is a diagram illustrating an outline of an information processing system according to the embodiment.

As illustrated in FIG. 1, an information processing system 1 according to the embodiment includes a user terminal 10, an information bank device 20 (information bank device 20a, 20b), and an information user device 30 (information user device 30a, 30b). The information bank device 20 functions as a generation device that generates information for verification using zero-knowledge proof. The information user device 30 functions as a verification device that performs verification using the zero-knowledge proof.

The following describes an example in which, in the information processing system 1 according to the embodiment, the information bank device 20 implements information management service for managing personal information of a user, which is an example of confidential information, and information providing service for providing a user of the information user device 30 with personal information. The service form implemented by the information processing system 1 according to the embodiment is not particularly limited to this example. The confidential information may be information on companies and the like as well as the personal information, and may be various types of information such as information that needs to be kept anonymous and information whose source should not be revealed.

The user terminal 10, the information bank device 20, and the information user device 30 are connected to a communication network 100. The user terminal 10 and the information bank device 20 perform data communication for sending and receiving various types of data via the communication network 100. The information bank device 20 and the information user device 30 perform data communication for sending and receiving various types of data via the communication network 100.

The communication network 100 may be implemented by a public line network such as the Internet, a telephone line network, or a satellite communication network, various local area networks (LANs) including Ethernet (registered trademark), and a wide area network (WAN). The communication network 100 may be also implemented by a wireless communication network such as Wi-Fi (registered trademark) or Bluetooth (registered trademark). Alternatively, the communication network 100 may be implemented by a dedicated line network such as an Internet protocol-virtual private network (IP-VPN).

The communication network 100 may include a peer-to-peer network (hereinafter referred to as a “P2P network”). The P2P network is sometimes called a P2P distributed file system. The information processing system 1 can use, for example, a distributed P2P database distributed in the P2P network. The P2P database is constructed by, for example, a plurality of information processing devices 110a to 110d. An example of the P2P database is a blockchain system 110 distributed in the P2P network.

The blockchain system 110 manages historical data (log) indicating a history of requests for and acquisition of personal information in the information processing system 1. Spoofing and falsification of historical data are prevented by giving a digital signature using an encryption key to each set of historical data or by encrypting each set of transaction data. Further, each set of historical data is made public and shared by all of the information processing devices 110a to 110d.

As illustrated in FIG. 2, a user U1 who intends to register information in the information providing service of the information bank device 20 operates the user terminal 10 to register personal information in the information bank device 20. The user U1 registers, along with the registration of the personal information, a disclosure destination to which provision of the personal information is permitted.

The information bank device 20 manages the personal information registered by the user U1. The information bank device 20 performs setup processing for generating, for different conditions, a plurality of conditional expressions that define the personal information under one or more conditions. In the setup processing, the same random number is added to each of the generated conditional expressions, and the same random number indicates that each of the conditional expressions defines personal information belonging to a specific individual. As the random number, information that only the user U1 knows, such as personal information, can be used. Further, in the setup processing, a certification key used for the zero-knowledge proof and a verification key are generated together for each of the conditional expressions generated.

Further, the information bank device 20 generates a plurality of proofs based on each of the conditional expressions (hereinafter, appropriately referred to as a proof) as certification information used for verification using the zero-knowledge proof. The proof is information for proving, for example, to a user of the information user device 30, that personal information satisfying the conditions specified by the user of the information user device 30 is known without disclosing the personal information. For example, the information user device 30 uses the verification key to verify the proof generated with the certification key, and thereby, can execute a condition determination as to whether or not the information bank device 20 knows the personal information satisfying the conditions.

When receiving a request for personal information from the information user device 30, the information bank device 20 provides the information user device 30 with a proof that matches the specified conditions among the plurality of proofs. Further, the information bank device 20 provides, along with the proof, public information and the verification key used for the verification of the proof in accordance with the information user device 30.

The information user device 30 requests personal information from the information bank device 20 to verify the proof acquired from the information bank device 20. The request for personal information is made using, for example, a query that specifies search conditions.

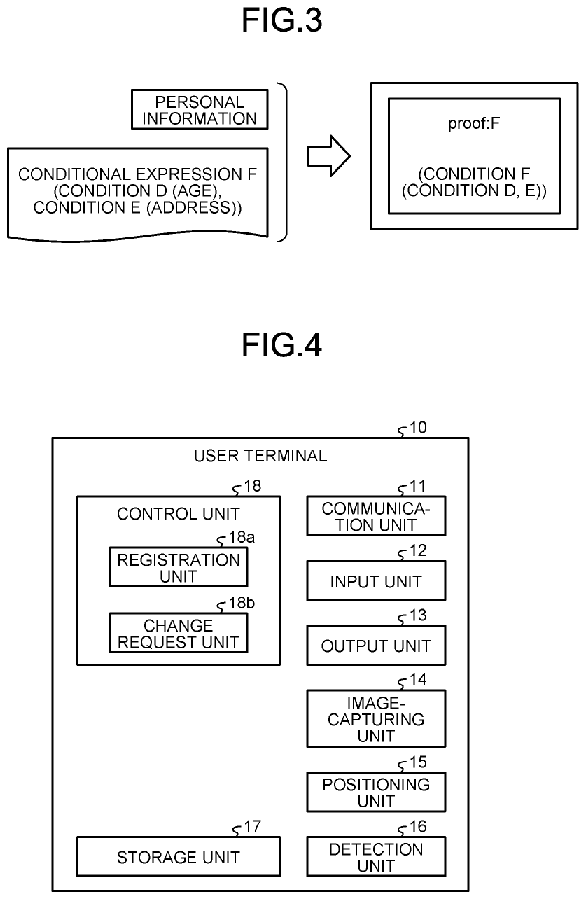

FIG. 3 is a diagram illustrating an example of a generation method of certification information according to a comparative example. The personal information can be defined by one or more conditions such as age, telephone number, and address. For example, as illustrated in FIG. 3, on the basis of personal information on a user and a conditional expression F including two conditions of a condition D that defines an age and a condition E that defines an address, a “proof:F” based on the conditional expression F can be generated. In such a case, for example, if the age of the user is changed, the entirety of the “proof:F” generated on the basis of the conditional expression F including the two conditions of the condition D and the condition E needs to be regenerated even if the address is not changed.

On the other hand, in the information processing system 1 according to the embodiment, a plurality of conditional expressions that defines personal information under one or more conditions is generated for different conditions. In the information processing system 1 according to the embodiment, a plurality of proofs based on each of the conditional expressions is generated as the certification information used for verification using the zero-knowledge proof. Therefore, in the information processing system 1 according to the embodiment, the conditional expression that defines personal information under one or more conditions can be partially managed for different conditions. As a result, according to the information processing system 1 of the embodiment, even if the personal information or the condition is changed, the proof generated for each conditional expression can be individually updated, and the processing load associated with the change of the certification information can be reduced.

### 2. Functional Configuration Example

Subsequently, an example of the functional configuration of each device included in the information processing system 1 according to the embodiment is described.

(2-1. User Terminal)

The user terminal 10 is a user device operated by a user who uses the information management service provided by the information bank device 20. The user terminal 10 is implemented by, for example, an information processing device such as a mobile phone including a smartphone, a tablet terminal, a desktop PC, a laptop PC, or a personal digital assistant (PDA).

FIG. 4 is a block diagram illustrating an example of the functional configuration of a user terminal according to the embodiment. As illustrated in FIG. 4, the user terminal 10 includes a communication unit 11, an input unit 12, an output unit 13, an image-capturing unit 14, a positioning unit 15, a detection unit 16, a storage unit 17, and a control unit 18.

FIG. 4 illustrates an example of the functional configuration of the user terminal 10 according to the embodiment, and the embodiment is not particularly limited to the example illustrated in FIG. 4, and any configuration capable of implementing various processing of the user terminal 10 can be used. Further, the constituent elements of the user terminal 10 illustrated in FIG. 4 are functionally conceptual and are not necessarily configured physically as illustrated in FIG. 4. For example, the specific form of distribution and integration of the functional blocks is not limited to the one illustrated in the drawings, and all or a part thereof can be configured by functionally or physically distributing and integrating in arbitrary units according to various loads, usage conditions, and the like.

The communication unit 11 is implemented by, for example, a network interface card (NIC), or the like. The communication unit 11 is connected to the communication network 100 by wire or wirelessly, and sends/receives information to/from the information bank device 20 or the like via the communication network 100.

The input unit 12 includes a keyboard and a mouse, and receives various operations from the user of the user terminal 10. The operation that the input unit 12 receives from the user includes a user registration operation required in order to use the information management service provided by the information bank device 20, and an operation of registering (uploading) personal information. The input unit 12 may have a sound input device such as a microphone, and can receive input such as a user's voice via a voice input device.

The output unit 13 includes a display and a speaker, and outputs various types of information. The information outputted by the output unit 13 includes a user registration operation provided by the information bank device 20 and a user interface with which to perform registration operation of personal information.

The image-capturing unit 14 includes a device such as a camera and captures an image. Data such as a facial image and an iris image of the user acquired by the image-capturing unit 14 can be registered as one piece of the personal information of the user if such data can be handled in the information management service.

The positioning unit 15 includes a global positioning system (GPS) and acquires the position of the user terminal 10. The positional information of the user acquired by the positioning unit 15 can be registered as one piece of the personal information of the user if the positional information can be handled in the information management service.

The detection unit 16 includes an acceleration sensor, a gyro sensor, and a biometric sensor, and detects various types of information acting on the user terminal 10. Biometric information such as feature amounts and heartbeat waveforms that correspond to gait of the user, and fingerprint feature points acquired by the detection unit 16 can be registered as one piece of the personal information of the user if the biometric information can be handled in the information management service.

The storage unit 17 stores programs, data, and the like for implementing various processing functions executed by the control unit 18. The storage unit 17 is implemented by, for example, a semiconductor memory device such as a random access memory (RAM) or a flash memory, or a storage device such as a hard disk or an optical disk. Programs stored in the storage unit 17 include a control program for implementing a processing function corresponding to each unit of the control unit 18. The control program provides a processing function for causing the user terminal 10 to execute processing related to the user registration operation, the personal information registration operation, and the like, which are required for the use of the information management service.

The control unit 18 executes various processing in the user terminal 10. The control unit 18 is implemented by, for example, a processor such as a central processing unit (CPU) or a micro processing unit (MPU). For example, the control unit 18 is implemented in response to various programs, stored in the storage device of the user terminal 10, executed by the processor using a random access memory (RAM) or the like as a work area. Alternatively, the control unit 18 may be implemented, for example, by an integrated circuit such as an application specific integrated circuit (ASIC) or a field programmable gate array (FPGA).

The control unit 18 includes a registration unit 18a and a change request unit 18b, and the individual units implement or execute the functions and operations of various processing of the user terminal 10.

The registration unit 18a executes processing for performing the user registration operation, the personal information registration operation, and the like, which are required for the use of the information management service. The change request unit 18b executes processing for making a request to change the personal information registered in the information bank device 20.

(2-2. Information Bank Device)

The information bank device 20 is a device managed by a service provider that provides information management service for managing personal information of a user and information providing service for providing the information user device 30 with personal information. The information bank device 20 is implemented by an information processing device such as a server in a cloud environment.

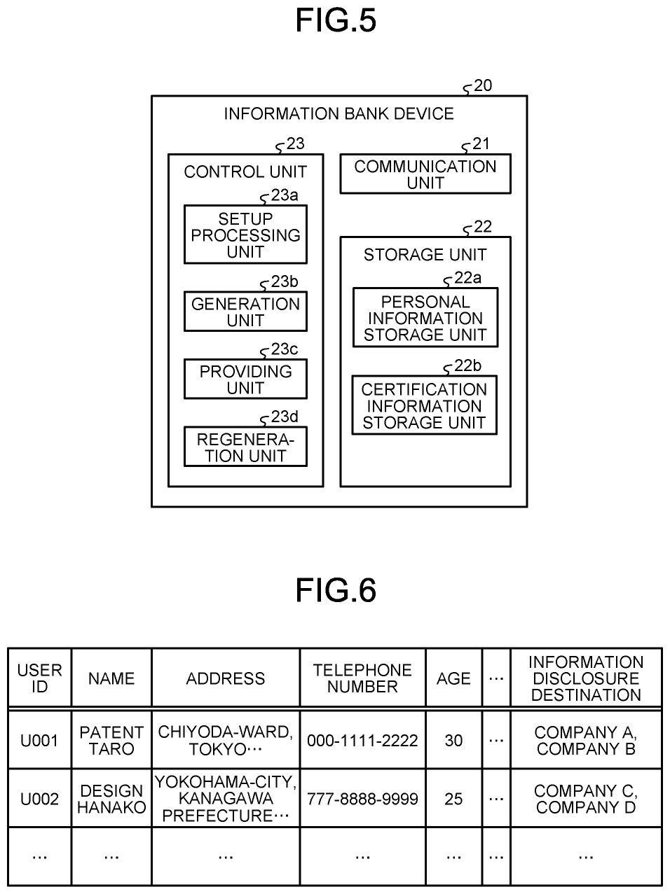

FIG. 5 is a block diagram illustrating an example of the functional configuration of an information bank device according to the embodiment. As illustrated in FIG. 5, the information bank device 20 includes a communication unit 21, a storage unit 22, and a control unit 23.

FIG. 5 illustrates an example of the functional configuration of the information bank device 20 according to the embodiment, and the embodiment is not particularly limited to the example illustrated in FIG. 5, and any configuration capable of implementing various processing of the information bank device 20 can be used. Further, the constituent elements of the information bank device 20 illustrated in FIG. 5 are functionally conceptual and are not necessarily configured physically as illustrated in FIG. 5. For example, the specific form of distribution and integration of the functional blocks is not limited to the one illustrated in the drawings, and all or a part thereof can be configured by functionally or physically distributing and integrating in arbitrary units according to various loads, usage conditions, and the like.

The communication unit 21 is implemented by, for example, a network interface card (NIC), or the like. The communication unit 21 is connected to the communication network 100 by wire or wirelessly, and sends/receives information to/from the user terminal 10 and the information user device 20 or the like via the communication network 100.

The storage unit 22 stores programs, data, and the like for implementing various processing functions executed by the control unit 23. The storage unit 22 is implemented by, for example, a semiconductor memory device such as a random access memory (RAM) or a flash memory, or a storage device such as a hard disk or an optical disk. Programs stored in the storage unit 22 include a control program for implementing a processing function corresponding to each unit of the control unit 23. The control program provides various processing functions for implementing the user registration, the personal information registration, and the like executed with the user terminal 10 in order to provide the information management service. In addition, the control program provides various processing functions for implementing the information providing service.

As illustrated in FIG. 5, the storage unit 22 includes a personal information storage unit 22a and a certification information storage unit 22b.

FIG. 6 is a diagram illustrating an outline of information stored in a personal information storage unit according to the embodiment. As illustrated in FIG. 6, the personal information storage unit 22a includes a plurality of items indicating attributes identifying the personal information and an item indicating an information disclosure destination in correlation with the item of the user ID. In the item of the user ID, a user ID uniquely given to the user who has registered as a user of the information management service is stored. The personal information storage unit 22a includes, as the items indicating the attributes of the personal information, for example, items of a name, an address, a telephone number, and an age, and stores personal information corresponding to the items.

Examples of the personal information that can be handled by the information bank device 20 include confidential information such as a card number, a combination of known information, sensing data, my number, and other information such as credit card information. Examples of the combination of known information include a family name, an address or telephone number of parents' home, and a parent's maiden name, in addition to the home address and the telephone number. Examples of the sensing data include fingerprints, positional information of a specific location such as home, and biometric information such as an iris, face, and gait. In the item of the information disclosure destination, information is stored which identifies a company or the like to which the user gives a permission to provide the personal information at the time of user registration in the information management service. Note that, as the information for identifying a company or the like to which provision of the personal information is permitted, conditions based on the purpose of use of an information user and conditions based on compensation for providing the information may be stored, in addition to the name of the company to be set as the disclosure destination. For example, configuration is possible in which information is not disclosed to information users who request information provision for the purpose of direct marketing. Another configuration is possible in which information is disclosed only in a case where compensation is paid for information provision or where the compensation exceeds a predetermined amount. Further, the personal information does not have to be actual data itself, and may be encrypted data or data anonymously processed. Further, the information disclosure destination may be set individually for the items of personal information, or may be set collectively for all pieces of personal information.

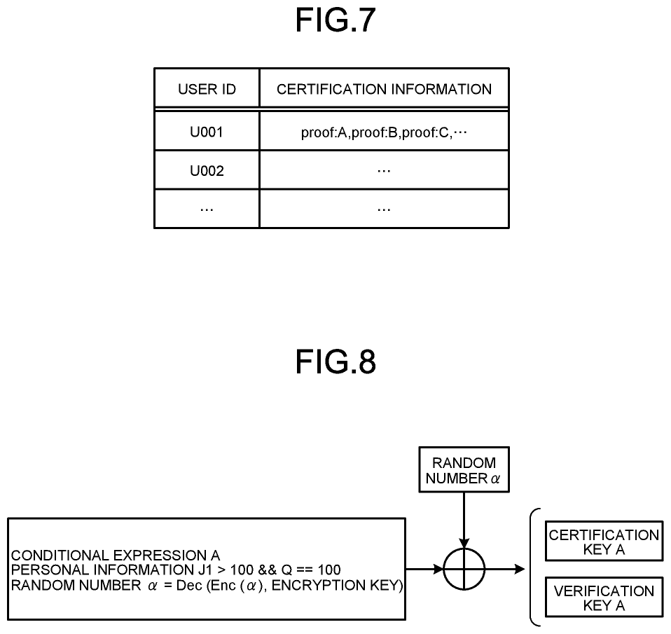

FIG. 7 is a diagram illustrating an outline of information stored in a certification information storage unit according to the embodiment. As illustrated in FIG. 7, the certification information storage unit 22b includes the item of the user ID and an item of the certification information, and the items are correlated with each other. In the item of the user ID, a user ID uniquely given to the user who has registered as a user of the information management service is stored. Information on the proof generated at the time of user registration is stored in the item of the certification information.

The control unit 23 executes various processing in the information bank device 20. The control unit 23 is implemented by, for example, a processor such as a central processing unit (CPU) or a micro processing unit (MPU). For example, the control unit 23 is implemented in response to various programs, stored in the storage device of the information bank device 20, executed by the processor using a random access memory (RAM) or the like as a work area. Alternatively, the control unit 23 may be implemented, for example, by an integrated circuit such as an application specific integrated circuit (ASIC) or a field programmable gate array (FPGA).

As illustrated in FIG. 5, the control unit 23 includes a setup processing unit 23a, a generation unit 23b, a providing unit 23c, and a regeneration unit 23d, and each of the units implements or executes the functions and operations of various processing of the information bank device 20.

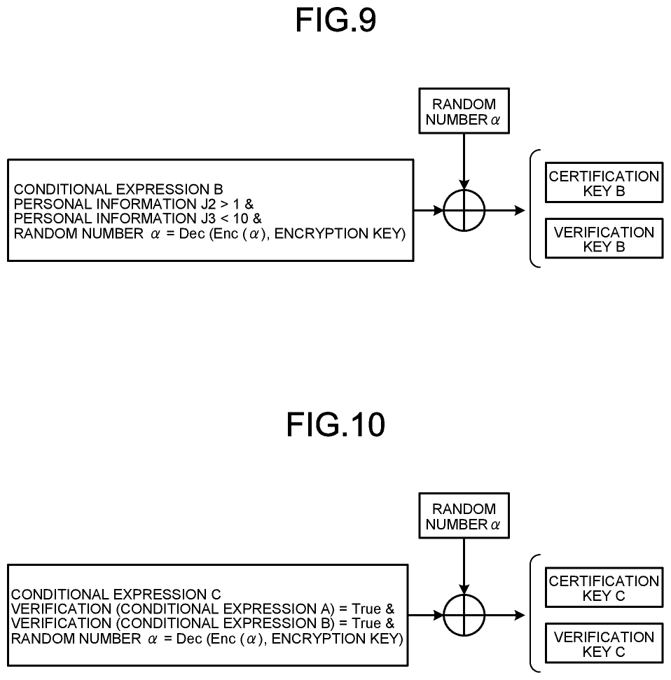

The setup processing unit 23a functions as a conditional expression generation unit that generates, for different conditions, a plurality of conditional expressions that define the confidential information under one or more conditions. The setup processing by the setup processing unit 23a is performed only once as the initial setting. FIGS. 8 to 10 are diagrams illustrating an outline of the setup processing according to the embodiment.

For example, as illustrated in FIGS. 8 to 10, the setup processing unit 23a generates, for example, a conditional expression A that defines one piece of personal information J1 under a predetermined condition, a conditional expression B that defines each of two pieces of personal information J2 and J3 under a predetermined condition, and a conditional expression C defining that the conditional expression A and the conditional expression B are correct. In the examples illustrated in FIGS. 8 to 10, the personal information J1 to J3 correspond to personal information that can be defined numerically.

For example, the conditional expression A defines a condition that certain personal information J1 is greater than 100. The conditional expression A includes a condition that public information Q is equal to 100. In addition, the conditional expression B defines a condition that certain personal information J2 is greater than 1 and the personal information J3 is less than 10. The conditional expression C defines that the conditional expression A (the personal information J1 is greater than 100) and the conditional expression B (the personal information J2 is greater than 1 and the personal information J3 is less than 10) are both correct.

Further, as illustrated in FIGS. 8 to 10, the same random number α is added to the conditional expressions A to C as information indicating that the personal information defined by each of the conditional expressions A to C belongs to a specific individual. The random number α can thus prove that each of the conditional expressions A to C defining the personal information J1 to J3 defines the personal information belonging to the identical user, and can prevent verification with a random combination at the time of proof verification in the information user device 30. When registering personal information of the user of the user terminal 10, the setup processing unit 23a generates information (Enc(α)) in which the random number α is encrypted with an encryption key. The setup processing unit 23a registers the information (Enc(α)) in which the random number α is encrypted as the public information Enc(α) in the blockchain system 110. Further, the setup processing unit 23a can register the public information Q in the blockchain system 110 when the personal information of the user of the user terminal 10 is registered. As the public information Q, for example, personal information that the user of the user terminal 10 has determined to be publicly available can be used and can be obtained from the user of the user terminal 10. The public information Enc(α) and the public information Q registered in the blockchain system 110 as the public information are provided to the information user device 30 together with the proof, and are used at the time of verification of the proof by the information user device 30 using the zero-knowledge proof.

Further, the setup processing unit 23a generates a certification key A and a verification key A corresponding to the generated conditional expression A, a certification key B and a verification key B corresponding to the generated conditional expression B, and a certification key C and a verification key C corresponding to the generated conditional expression C. For example, the setup processing unit 23a converts each of the conditional expressions A to C into a column of a formula expressed by addition and multiplication to obtain R1CS in which the converted column is regarded as a matrix. The setup processing unit 23a then performs scalar multiplication with elliptic curve cryptography using, as a scalar value, the random number α and the value of the matrix obtained by converting R1CS into QAP, and generates a certification key and a verification key.

In this way, the setup processing unit 23a can partially manage, for different conditions, the conditional expression that defines the personal information under one or more conditions.

The generation unit 23b generates, for each of the conditional expressions, a proof based on a plurality of conditional expressions generated by the setup processing unit 23a as certification information used for verification using the zero-knowledge proof. The generation unit 23b functions as a certification information generation unit that generates a plurality of proofs based on each of the conditional expressions as the certification information.

In response to a user registration request received from the user terminal 10, the generation unit 23b executes user registration processing. Specifically, the generation unit 23b issues a user ID given to the user of the user terminal 10 which is the source of the user registration request. The generation unit 23b then sends the user registration request including the user ID to the blockchain system 110.

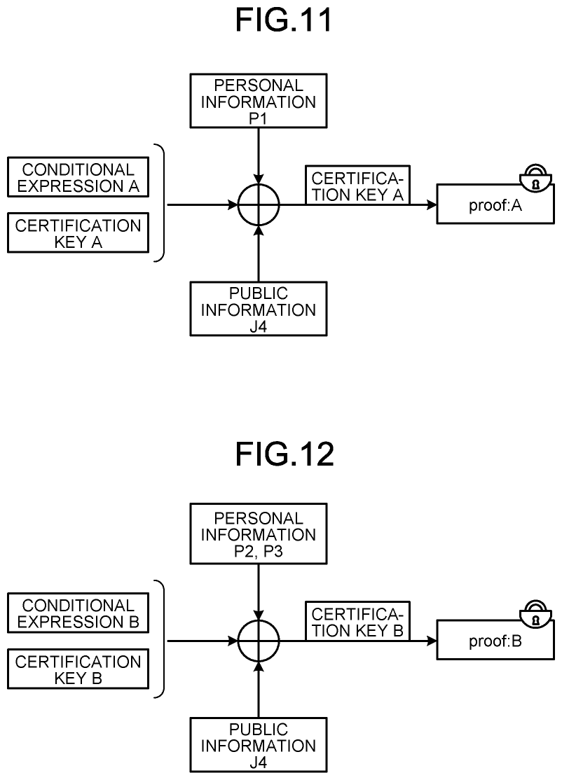

Further, after the completion of the user registration processing, the generation unit 23b stores the personal information acquired from the user terminal 10 in the personal information storage unit 22a in association with the user ID. When the personal information is completely saved, the generation unit 23b generates a proof. FIGS. 11 to 13 are diagrams illustrating an outline of a generation method of certification information according to the embodiment. In the following description, public information J4 refers to at least one of the public information Enc(α) and the public information Q registered in the blockchain system 110.

For example, as illustrated in FIG. 11, the generation unit 23b calculates the scalar value by multiplying the QAP obtained based on the certification key A and the conditional expression A generated by the setup processing unit 23a, personal information P1 of the user, and public information J4 (Enc(α), Q). The generation unit 23b then uses the certification key A to encrypt the scalar value calculated, adds the encrypted values together to generate “proof:A” based on the conditional expression A.

Further, as illustrated in FIG. 12, the generation unit 23b calculates the scalar value by multiplying the QAP obtained based on the certification key B and the conditional expression B generated by the setup processing unit 23a, personal information J2 and J3 of the user, and the public information J4 (Enc(α)). The generation unit 23b then uses the certification key B to encrypt the scalar value calculated, adds the encrypted values together to generate “proof:B” based on the conditional expression B.

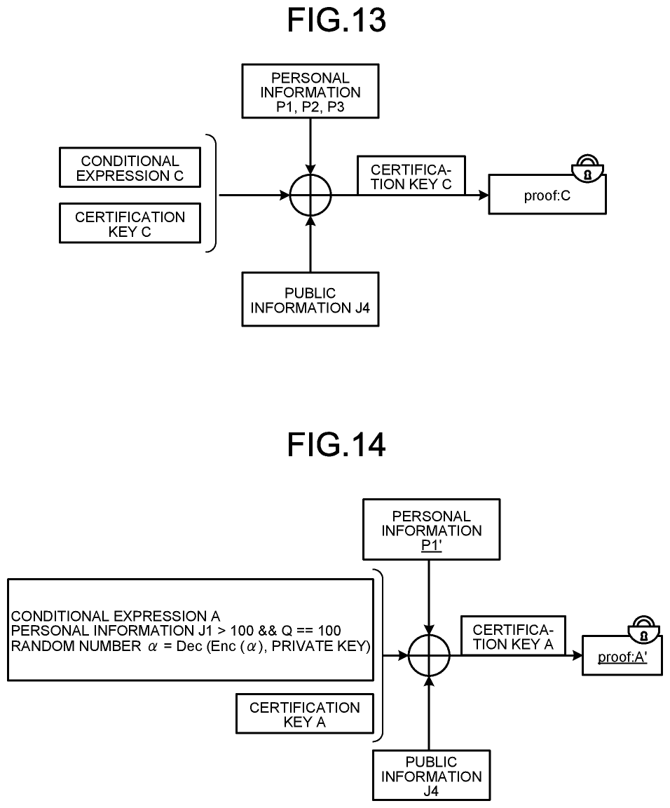

Further, as illustrated in FIG. 13, the generation unit 23b calculates the scalar value by multiplying the QAP obtained based on the certification key C and the conditional expression C generated by the setup processing unit 23a, the personal information J1 to J3 of the user, and the public information J4 (Enc(α)). The generation unit 23b then uses the certification key C to encrypt the scalar value calculated, adds the encrypted values together to generate “proof:C” based on the conditional expression C.

The generation unit 23b stores the plurality of proofs generated in the certification information storage unit 22b in association with the user ID. The generation unit 23b also registers the generated proof in the blockchain system 110 in association with the user ID. When registering the proof in the blockchain system 110, the generation unit 23b registers the public information Enc(α) and the public information Q in accordance with the blockchain system 110 in association with the identical user ID used for the registration of the proof.

The processing by the setup processing unit 23a and the generation unit 23b described above can be performed by using, for example, “zk-SNARK”, which is an existing technology for non-interactively implementing the proposition of the zero-knowledge proof disclosed in the following documents, for example.

<https://eprint.iacr.org/2016/260.pdf>

<http://zerocash-project.org/media/pdf/zerocash-oakland2014.pdf>

The providing unit 23c provides a proof (proof list) that matches the specified condition from the plurality of proofs generated by the generation unit 23b in response to the request for personal information received from the information user device 30. For example, the providing unit 23c determines whether or not there is registration of personal information in which the user of the information user device 30, which is the request source of personal information, is set as the information disclosure destination. If the personal information in which the user of the information user device 30 is set as the information disclosure destination is registered, then a proof that matches the condition specified by the information user device 30 is searched from among the plurality of proofs stored in the certification information storage unit 22b. In other words, in response to the request for personal information received from the information user device 30, the providing unit 23c searches for a proof generated using personal information that matches the search condition specified in the query from the plurality of proofs stored in the certification information storage unit 22b. The providing unit 23c then sends a list of the proofs generated using the personal information that matches the search condition to the information user device 30.

In response to new personal information corresponding to a change request received from the user terminal 10, the regeneration unit 23d updates personal information stored in association with a user ID of a user who is the sender of the change request with the new personal information.

In addition, the regeneration unit 23d functions as a certification information generation unit that regenerates and updates, in response to the change of the personal information defined in the conditional expression, a proof based on the conditional expression that defines the personal information corresponding to the change. FIG. 14 is a diagram illustrating an outline of an updating method of certification information according to the embodiment. In a case where the personal information P1 is changed to personal information P1′, the regeneration unit 23d discards the proof:A based on the personal information P1. Subsequently, as illustrated in FIG. 14, the regeneration unit 23d regenerates proof:A′ based on the new personal information P1′ received from the user terminal 10. The regeneration unit 23d then stores the regenerated proof:A′ into the certification information storage unit 22b in association with the user ID of the user who is the sender of the change request. For example, in response to a request to change the address received from the user, the regeneration unit 23d discards the proof based on the previous address of the user, regenerates a proof using a new address, and stores the proof regenerated into the certification information storage unit 22b. As described above, the regeneration unit 23d can individually update only the proof based on the changed personal information. Therefore, the processing time required to regenerate a proof can be shortened.

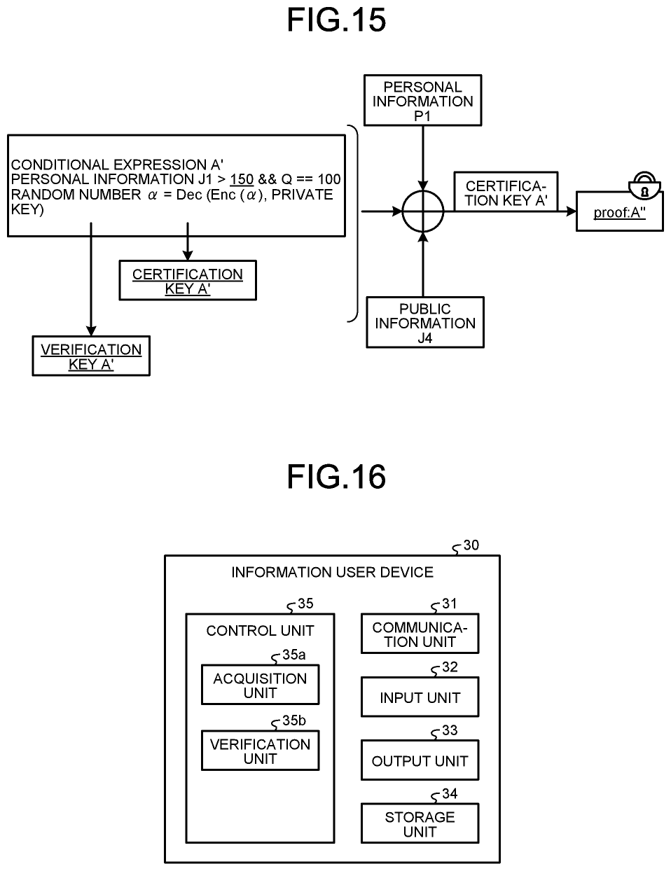

Further, in response to the change of the condition included in the conditional expression, the regeneration unit 23d regenerates and updates a proof based on the conditional expression including the condition to be changed. FIG. 15 is a diagram illustrating an outline of an updating method of certification information according to the embodiment. In a case where the conditional expression A including the condition “personal information J1>100” is changed to a conditional expression A′ including the condition “personal information J1>150”, the regeneration unit 23d discards the proof:A that is generated by using the conditional expression A. Subsequently, as illustrated in FIG. 15, the regeneration unit 23d generates a certification key A′ and a verification key A′ using the conditional expression A′ including the new condition “personal information J1>150”, and generates a new proof:A″ based on the conditional expression A′. The regeneration unit 23d then stores the regenerated proof A″ into the certification information storage unit 22b. For example, in a case where a conditional expression that defines the age condition of the user is changed from a conditional expression that defines the condition of 20 years-old and older to a conditional expression that defines the condition of 30 years-old and older, the regeneration unit 23d discards the proof based on the conditional expression that defines the condition of 20 years-old and older. Then, a proof based on the conditional expression that defines the condition of 30 years-old and older is newly regenerated and stored into the certification information storage unit 22b. As described above, the regeneration unit 23d can individually update only the proof including the condition to be changed. Therefore, the processing time required to regenerate a proof can be shortened.

In a case where providing the proof to the information user device 30, the information bank device 20 registers a usage history of the information providing service by the information user device 30 in the blockchain system 110. The information bank device 20 can register, as the usage history of the information providing service, for example, information about the user of the information user device 30, the date and time at which the request has been made, and information about the provided proof in the blockchain system 110.

(2-3. Information User Device)

The information user device 30 is a device operated by a user (information user) who uses the information providing service provided by the information bank device 20. The information user device 30 is implemented by, for example, an information processing device such as a mobile phone including a smartphone, a tablet terminal, a desktop PC, a laptop PC, or a personal digital assistant (PDA).

FIG. 16 is a block diagram illustrating an example of the functional configuration of an information user device according to the embodiment. As illustrated in FIG. 16, the information user device 30 includes a communication unit 31, an input unit 32, an output unit 33, a storage unit 34, and a control unit 35.

FIG. 16 illustrates an example of the functional configuration of the information user device 30 according to the embodiment, and the embodiment is not particularly limited to the example illustrated in FIG. 16, and any configuration capable of implementing various processing of the information user device 30 can be used. Further, the constituent elements of the information user device 30 illustrated in FIG. 16 are functionally conceptual and are not necessarily configured physically as illustrated in FIG. 16. For example, the specific form of distribution and integration of the functional blocks is not limited to the one illustrated in the drawings, and all or a part thereof can be configured by functionally or physically distributing and integrating in arbitrary units according to various loads, usage conditions, and the like.

The communication unit 31 is implemented by, for example, a network interface card (NIC), or the like. The communication unit 31 is connected to the communication network 100 by wire or wirelessly, and sends/receives information to/from the information bank device 20 or the like via the communication network 100.

The input unit 32 includes a keyboard and a mouse, and receives various operations from the user of the information user device 30. The operations that the input unit 32 receives from the user include a login operation necessary to receive the information providing service, and an input operation of a search query for requesting personal information to the information bank device 20. The input unit 32 may have a sound input device such as a microphone, and can receive input such as a user's voice via a voice input device.

The output unit 33 includes a display and a speaker, and outputs various types of information. The information outputted by the output unit 33 includes a user interface with which to receive a login operation necessary to receive the information providing service, a proof provided by the information bank device 20, and data on public information, a verification key, and personal information.

The storage unit 34 stores programs, data, and the like for implementing various processing functions executed by the control unit 35. The storage unit 34 is implemented by, for example, a semiconductor memory device such as a random access memory (RAM) or a flash memory, or a storage device such as a hard disk or an optical disk. Programs stored in the storage unit 34 include a control program for implementing a processing function corresponding to each unit of the control unit 35. The control program provides a processing function for causing the information user device 30 to execute processing related to the login operation, the search query input operation, and the like, which are required for the use of the information providing service.

The control unit 35 executes various processing in the information user device 30. The control unit 35 is implemented by, for example, a processor such as a central processing unit (CPU) or a micro processing unit (MPU). For example, the control unit 35 is implemented in response to various programs, stored in the storage device of the information user device 30, executed by the processor using a random access memory (RAM) or the like as a work area. Alternatively, the control unit 35 may be implemented, for example, by an integrated circuit such as an application specific integrated circuit (ASIC) or a field programmable gate array (FPGA).

The control unit 35 includes an acquisition unit 35a and a verification unit 35b, and the individual units implement or execute the functions and operations of various processing of the information user device 30.

The acquisition unit 35a acquires a proof that is generated by using personal information that matches the specified condition from a plurality of proofs based on each of the conditional expressions generated for different conditions in order to define confidential information under one or more conditions. In requesting personal information, a user of the information user device 30 can specify search conditions by a search query such as “a man aged 30 or over living in Tokyo”. The acquisition unit 35a can acquire a proof that matches the specified condition from the blockchain system 110, for example, on the basis of a list of proofs acquired from the information bank device 20.

In addition, the acquisition unit 35a acquires, from the blockchain system 110, the verification key and the public information necessary to execute a condition determination as to whether or not the personal information can be acquired by using the zero-knowledge proof together with the proof.

In addition, the acquisition unit 35a can acquire, from the blockchain system 110, the proof regenerated in association with the change of the personal information and the proof regenerated in association with the change of the conditions.

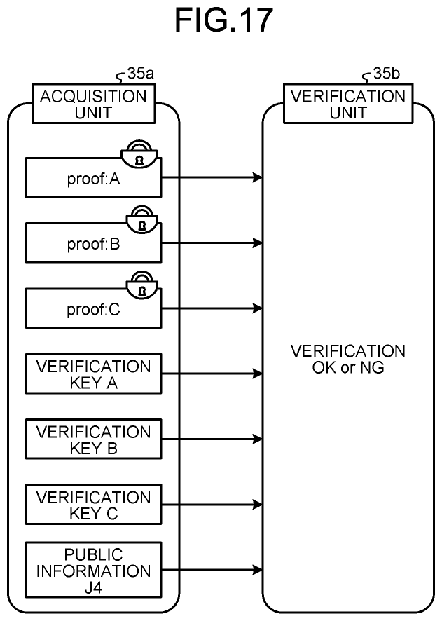

The verification unit 35b verifies the proof acquired by the acquisition unit 35a, and executes a condition determination as to whether or not it is possible to acquire the personal information that matches the conditions specified at the time of request for the personal information. Specifically, if a match is found between the result of pairing (encryption processing) of the proof acquired by the acquisition unit 35a and the result of pairing of the verification key and the open information, then the verification unit 35b determines that the verification result is “OK”. On the other hand, if no match is found between the result of pairing (encryption processing) of the proof acquired by the acquisition unit 35a and the result of pairing of the verification key and the public information, then the verification unit 35b determines that the verification result is “NG”. FIG. 17 is a diagram illustrating an outline of verification processing according to the embodiment.

As illustrated in FIG. 17, it is assumed that the acquisition unit 35a acquires the proofs:A to C as proofs that match the conditions, and acquires, together with the proofs:A to C, the verification keys A to C corresponding to the respective proofs and the public information J4 (Enc(α), Q). In such a case, the verification unit 35b first executes verification using the proof:A, the public information J4 (Enc (α), Q), and the verification key A. Next, the verification unit 35b executes verification using the proof:B, the public information J4 (Enc (α)), and the verification key B. Finally, the verification unit 35b executes verification using the verification result of the proof:A, the verification result of the proof:B, the proof:C, the public information J4 (Enc (α)), and the verification key C. In the case illustrated in FIG. 17, as for the verification result by the verification unit 35b, when the verification result of the proof:A and the verification result of the proof:B are both “OK”, the verification result of the proof:C is also “OK”.

If the verification result by the verification unit 35b is “OK”, then it is determined that the personal information that matches the specified conditions can be acquired. On the other hand, if the verification result is NG, then it is determined that the personal information that matches the specified conditions cannot be acquired.

When determining that the personal information can be acquired, the verification unit 35b sends a request to acquire the personal information to the information bank device 20.

### 3. Example of Processing Steps

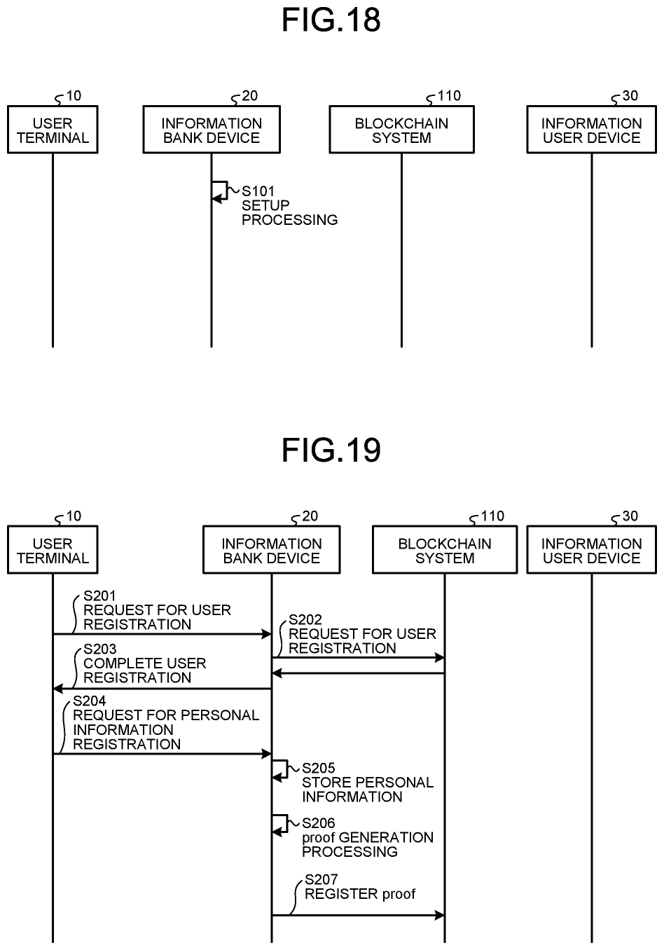

An example of the processing steps by the information processing system 1 according to the embodiment is described with reference to FIGS. 18 to 21. FIGS. 18 to 21 are sequence diagrams illustrating an example of processing steps by the information processing system 1 according to the embodiment.

The steps of the setup processing in the information processing system 1 are described with reference to FIG. 18. As illustrated in FIG. 18, the information bank device 20 executes setup processing for generating a conditional expression that defines the content of personal information (Step S101). In the setup processing, the certification key and the verification key corresponding to the generated conditional expression are generated together. The setup processing is performed only once as the initial setting.

The steps of processing from the user registration to the proof registration in the information processing system 1 are described with reference to FIG. 19. As illustrated in FIG. 19, the user terminal 10 sends a user registration request to the information bank device 20 (Step S201).

Upon receiving the user registration request, the information bank device 20 executes the user registration processing and sends the user registration request to the blockchain system 110 (Step S202). Upon receiving a registration completion response from the blockchain system 110, the information bank device 20 sends a notification of user registration completion to the user terminal (Step S203). In this way, the information bank device 20 performs user registration in both the subject device and the blockchain system 110.

When receiving the notification of user registration completion from the information bank device 20, the user terminal 10 sends a request for registration of the personal information (Step S204).

When receiving the request for registration of the personal information sent from the user terminal 10, the information bank device 20 stores the personal information included in the registration request in association with the user ID into the personal information storage unit 22a (Step S205).

The information bank device 20 executes proof generation processing using the personal information acquired in Step S205 (Step S206). The information bank device 20 registers the proof generated in the proof generation processing in the blockchain system 110 (Step S207). When registering the proof, the information bank device 20 registers the public information (Enc (α), Q) in accordance with the blockchain system 110.

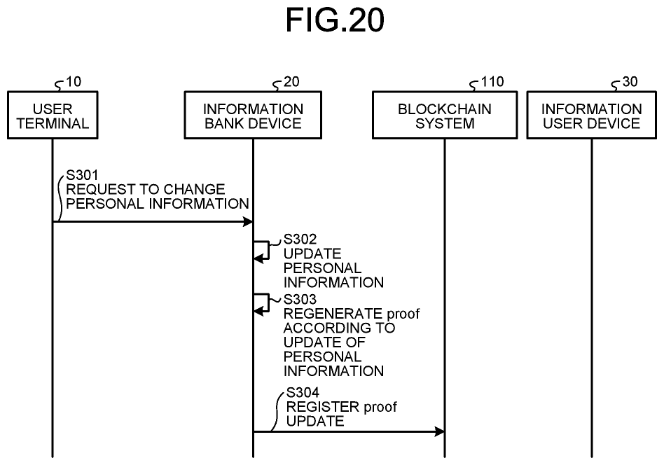

The steps of processing from the update of the personal information to the proof registration in the information processing system 1 are described with reference to FIG. 20. As illustrated in FIG. 20, the user terminal 10 sends a request to change the personal information to the information bank device 20 according to the user's operation (Step S301).

When receiving the request to change the personal information from the user terminal 10, the information bank device 20 updates personal information that is stored in association with the user ID of the user who is the sender of the change request with new personal information included in the change request (Step S302).

Subsequently, in response to the personal information changed, the information bank device 20 regenerates a proof based on the personal information corresponding to the change (Step S303).

After the proof is regenerated, the information bank device 20 registers the update of the regenerated proof in the blockchain system 110 (Step S304).

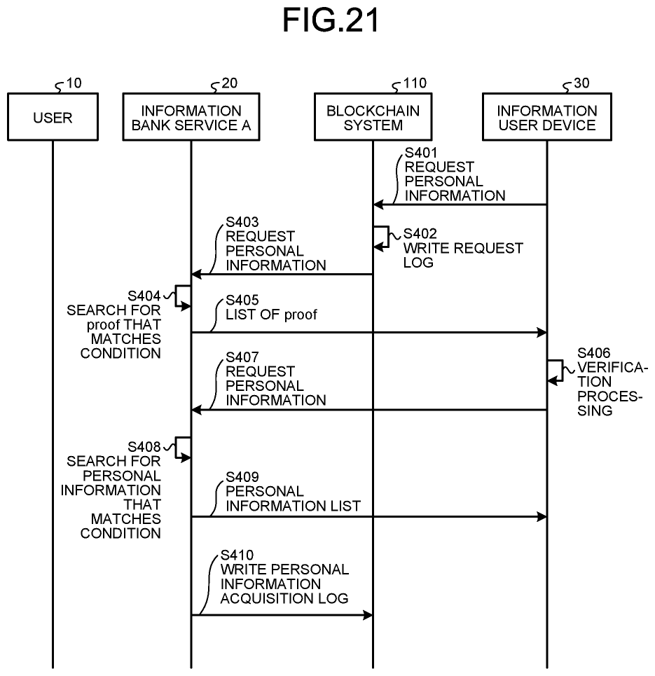

The steps of processing of requesting, verifying, and acquiring personal information in the information processing system 1 are described with reference to FIG. 21. As illustrated in FIG. 21, the information user device 30 sends a request for personal information to the blockchain system 110 by specifying a query for search conditions (Step S401). In a case where there is a plurality of the information bank devices 20 (for example, information bank devices 20a and 20b), each of the information bank devices 20 is connected to one another via the blockchain system 110 to exchange information with one another. Since the information user device 30 cannot determine in which information bank device 20 contains personal information that matches the specified conditions, the information user device 30 first requests personal information from the blockchain system 110. In requesting personal information, the information user device 30 specifies search conditions by a search query such as “a man aged 30 or over living in Tokyo”.

The blockchain system 110 writes information about the request for personal information received from the information user device 30 as a request log (Step S402) and sends the request for personal information to the information bank device (Step S403). In order to match the request log, a smart contract for request from the blockchain system 110 to the information bank device 20 is registered in the blockchain system 110.

The information bank device 20 receives the request for personal information from the blockchain system 110, and searches for a proof that matches the search conditions specified by the query from the plurality of proofs stored in the certification information storage unit 22b (Step S404).

The information bank device 20 sends a list of proofs generated using personal information that matches the search conditions to the information user device 30 (Step S405).

The information user device 30 acquires the proof, the public information, and the verification key from the blockchain system 110 on the basis of the list of proofs received from the information bank device 20, and executes the verification processing of the acquired proof (Step S406). The information user device 30 can acquire the proof guaranteed not to be modified in the blockchain system 110 by acquiring the proof from the blockchain system 110.

If the verification result is “OK”, then the information user device 30 sends the request for personal information to the information bank device 20 (Step S407).

The information bank device 20 searches for personal information that matches request conditions for personal information from the personal information stored in the personal information storage unit 22a (Step S408).

The information bank device 20 sends a list of personal information that matches the request conditions to the information user device 30 (Step S409).

The information bank device 20 writes information about personal information provided in response to the request from the information user device 30 to the blockchain system 110 as a personal information acquisition log (Step S410).

### 4. Modification Example

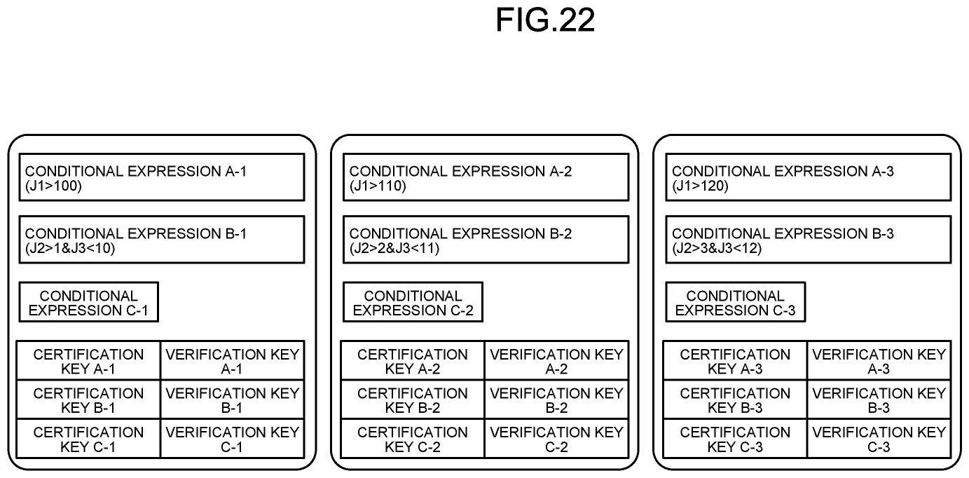

In the embodiment described above, the information bank device 20 may pre-generate a plurality of pre-generated conditional expressions as conditional expressions for defining various types of confidential information (personal information as an example) under one or more conditions. FIG. 22 is a diagram illustrating an outline of a conditional expression according to the modification example.

As illustrated in FIG. 22, the information bank device 20 generates, in advance, a plurality of conditional expressions A-1, A-2, A-3, B-1, B-2, B-3, C-1, C-2, C-3, and so on that include expected different conditions as the pre-generated conditional expressions. The information bank device 20 analyzes the content of the request from the user of the information providing service, for example, on the basis of the log stored in the blockchain system 110 to determine, on the basis of the analysis result, expected conditions according to patterns corresponding to the content of the request. This allows preparation of a conditional expression that reflects the content of the request of the information user.

The generation unit 23b selects a plurality of conditional expressions for defining the personal information from among the plurality of pre-generated conditional expressions generated in advance. The generation unit 23b then generates a proof for each of the conditional expressions selected.

As described above, according to the information bank device 20 of the modification example, the generation unit 23b selects a plurality of conditional expressions for defining the personal information from among the plurality of pre-generated conditional expressions generated in advance and use the selected conditional expressions. This eliminates the need for the setup processing for generating a plurality of conditional expressions, leading to reduction in the processing load.

Further, in response to the change of the personal information defined in the conditional expression, the regeneration unit 23d selects a conditional expression that defines the personal information corresponding to the change from among the pre-generated conditional expressions, and regenerates and updates a proof based on the selected conditional expression. As a result, a conditional expression for defining the personal information to be changed can be selected from among the plurality of pre-generated conditional expressions and used, and the processing load associated with the change of the proof that is the certification information can be reduced.

Further, in response to the change of the condition included in the conditional expression, the regeneration unit 23d selects a conditional expression including the condition to be changed from among the pre-generated conditional expressions, and regenerates and updates a proof based on the selected conditional expression. As a result, the conditional expression including the condition to be changed can be selected and used from among the plurality of pre-generated conditional expressions, and the processing load associated with the change of the proof that is the certification information can be reduced.

Further, the information bank device 20 may change, later, the conditions included in each of the pre-generated conditional expressions or add a new conditional expression on the basis of the analysis result of the content of the request from the user of the information providing service.

### 5. Other

Among the processing described in the embodiments, all or a part of the processing, described as automatic processing, can be performed manually, or all or a part of the processing, described as manual processing, can be performed automatically by a known method. In addition, the processing procedures, specific names, and information including various data and parameters indicated in the document and the drawings can be arbitrarily changed unless otherwise specified. For example, various types of information illustrated in the drawings are not limited to the illustrated information.

Further, the constituent elements of the individual devices illustrated in the drawings are functionally conceptual and are not necessarily configured physically as illustrated in the drawings. To be specific, the specific form of distribution and integration of the devices is not limited to the one illustrated in the drawings, and all or a part thereof can be configured by functionally or physically distributing and integrating in arbitrary units according to various loads, usage conditions, and the like.

For example, in the embodiment described above, an example in which the information bank device 20 of the information processing system 1 generates a conditional expression and a proof is described; however, the embodiment is not particularly limited to the example. For example, a configuration may be a system in which the user terminal 10 generates a conditional expression and a proof to register the conditional expression and the proof in the information bank device 20.

Further, the embodiments and the modification example described above can be appropriately combined to the extent that the processing contents do not contradict each other.

### 6. Summary

As described above, the information bank device 20 according to an embodiment of the present disclosure is an example of a generation device that generates certification information used for verification using the zero-knowledge proof, and the information bank device 20 includes the setup processing unit 23a (an example of the conditional expression generation unit) and the generation unit 23b (an example of the certification information generation unit). The setup processing unit 23a divides, for different conditions, a conditional expression that defines the personal information (an example of the confidential information) under one or more conditions to generate a plurality of conditional expressions. The generation unit 23b generates a plurality of proofs based on each of the conditional expressions as the certification information. Therefore, the information bank device 20 according to an embodiment of the present disclosure can partially manage, for different conditions, the conditional expression that defines the confidential information under one or more conditions. Thereby, according to an embodiment of the present disclosure, even if the personal information or the condition is changed, the proof generated for each conditional expression can be individually updated, and the processing load associated with the change of the certification information can be reduced.

Further, in the information bank device 20 according to an embodiment of the present disclosure, the setup processing unit 23a adds, to each of the conditional expressions generated, information indicating that the confidential information defined by each of the conditional expressions belongs to a specific individual. As a result, for example, even in a case where the personal information is defined by some conditional expressions and partially managed, it can be ensured that a plurality of proofs based on each of the conditional expressions is verified with the correct combination belonging to the specific individual.

Further, in the information bank device 20 according to an embodiment of the present disclosure, in response to the change of the personal information defined in the conditional expression, the regeneration unit 23d regenerates and updates a proof based on the personal information corresponding to the change. This allows for a flexible response to the change in the personal information.

Further, in the information bank device 20 according to an embodiment of the present disclosure, in response to the condition included in the conditional expression changed, the regeneration unit 23d regenerates and updates only a proof based on the conditional expression including the condition to be changed. This allows for a flexible response to the change in conditions of the conditional expressions.

Further, in the information bank device 20 according to an embodiment of the present disclosure, the generation unit 23b selects a plurality of conditional expressions that defines the confidential information from among a plurality of pre-generated conditional expressions that is generated in advance as conditional expressions for defining various types of personal information under one or more conditions. The generation unit 23b then generates a proof for each of the selected conditional expressions. As a result, it is possible to select and use a plurality of conditional expressions from the pre-generated conditional expressions without generating the same, which reduces the processing load.

Further, in the information bank device 20 according to an embodiment of the present disclosure, in response to the confidential information defined by the conditional expression changed, the generation unit 23b selects a conditional expression including a condition for defining the confidential information corresponding to the change from among the pre-generated conditional expressions. The generation unit 23b then regenerates and updates a proof based on the selected conditional expression. As a result, a conditional expression for defining the personal information to be changed can be selected from among the plurality of pre-generated conditional expressions and used, and the processing load associated with the change of the proof that is the certification information can be reduced.

Further, in the information bank device 20 according to an embodiment of the present disclosure, in response to the change of the condition included in the conditional expression, the generation unit 23b selects a conditional expression including the condition to be changed from among the pre-generated conditional expressions, and regenerates and updates a proof based on the selected conditional expression. As a result, the conditional expression including the condition to be changed can be selected and used from among the plurality of pre-generated conditional expressions, and the processing load associated with the change of the proof that is the certification information can be reduced.

Further, in the information bank device 20 according to an embodiment of the present disclosure, the pre-generated conditional expression is generated in advance on the basis of a request history of an information user who requests the disclosure of the confidential information. This allows preparation of a conditional expression that reflects the content of the request of the information user.

Further, the information user device 30 according to the embodiment of the present disclosure is an example of a verification device that performs verification using the zero-knowledge proof, and the information user device 30 includes the acquisition unit 35a and the verification unit 35b. The acquisition unit 35a acquires a proof generated using the personal information that matches the specified conditions as the certification information used for the verification using the zero-knowledge proof. The proof is a plurality of pieces of certification information that is generated to prove that the personal information is known for each of the conditional expressions that are generated by division every time one or more conditions for defining the personal information are added. The verification unit 35b verifies the proof acquired by the acquisition unit 35a, and executes a condition determination as to whether or not the confidential information matching the conditions can be acquired. The information user device 30 thus uses the zero-knowledge proof to verify whether or not the personal information matching the specified condition is known.

Further, the effects described in the present specification are merely examples and are not limited, and other effects may be provided.

### 7. Hardware Configuration

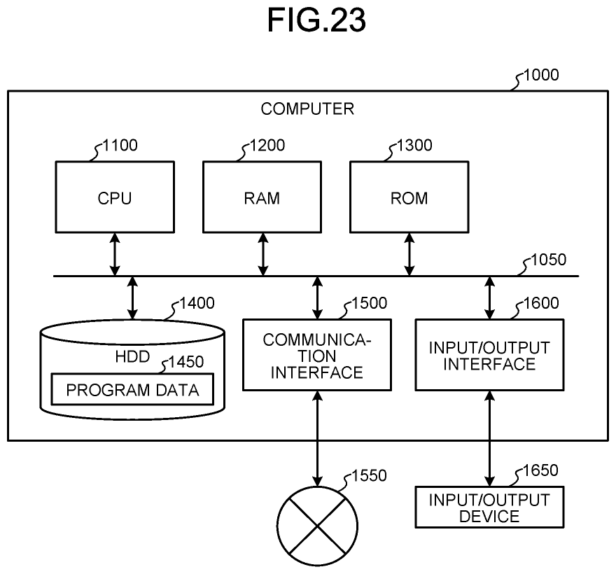

The information bank device 20 according to the embodiments described above is implemented by a computer 1000 having a configuration as illustrated in FIG. 23, for example. FIG. 23 is a hardware configuration diagram illustrating an example of the computer 1000 that implements the functions of the information bank device 20. The computer 1000 includes a CPU 1100, RAM 1200, read only memory (ROM) 1300, a hard disk drive (HDD) 1400, a communication interface 1500, and an input/output interface 1600. The units of the computer 1000 are connected to one another by a bus 1050.

The CPU 1100 operates on the basis of a program stored in the ROM 1300 or the HDD 1400 to control the units. For example, the CPU 1100 expands a program stored in the ROM 1300 or the HDD 1400 into the RAM 1200, and executes processing corresponding to various programs.

The ROM 1300 stores a boot program such as a basic input output system (BIOS) executed by the CPU 1100 at the start of the computer 1000, a program that depends on the hardware of the computer 1000, and the like.

The HDD 1400 is a recording medium that is readable by the computer 1000 and non-transiently records a program executed by the CPU 1100, data used by the program, and the like. Specifically, the HDD 1400 is a recording medium for recording a program for implementing the individual units (setup processing unit 23a, generation unit 23b, providing unit 23c, regeneration unit 23d) of the control unit 23 illustrated in FIG. 5, for example.

The communication interface 1500 is an interface for the computer 1000 to connect to an external network 1550 (for example, the Internet). For example, the CPU 1100 receives data from another device or sends data generated by the CPU 1100 to another device via the communication interface 1500.

The input/output interface 1600 is an interface for connecting an input/output device 1650 to the computer 1000. For example, the CPU 1100 receives data from an input device such as a keyboard and a mouse via the input/output interface 1600. The CPU 1100 also sends data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information bank device 20 according to the embodiment, the CPU 1100 of the computer 1000 executes a program loaded onto the RAM 1200 (program for implementing the processing of the individual units of the control unit 23, and so on). As a result, the functions of various processing executed by the individual units of the control unit 23 and the like are implemented. Further, the HDD 1400 stores a program for implementing the processing of the information bank device 20 according to the present disclosure, data stored in the storage unit 22, and the like. Note that the CPU 1100 reads the program data 1450 out of the HDD 1400 for execution; however, as another example, the programs may be acquired from another device via the external network 1550.

Further, the present technology may also be configured as below.

(1)

A generation device for generating certification information used for verification using zero-knowledge proof, including:

a conditional expression generation unit that generates, for different conditions, a plurality of conditional expressions that define confidential information under one or more conditions; and

a certification information generation unit that generates, as the certification information, a plurality of proofs based on each of the plurality of conditional expressions.

(2)

The generation device according to (1), wherein

the conditional expression generation unit

adds, to each of the plurality of conditional expressions generated, information indicating that confidential information defined by each of the plurality of conditional expressions belongs to a specific individual.

(3)

The generation device according to (2), wherein

the certification information generation unit

regenerates and updates, in response to the confidential information defined by the conditional expression changed, a proof based on a conditional expression that defines confidential information corresponding to the change.

(4)

The generation device according to (2), wherein

the certification information generation unit

regenerates and updates, in response to the condition included in the conditional expression changed, a proof based on a conditional expression including the condition to be changed.

(5)

The generation device according to (1), wherein

the conditional expression generation unit

selects a plurality of conditional expressions that defines confidential information from among a plurality of pre-generated conditional expressions that is generated in advance as the plurality of conditional expressions for defining various types of confidential information under one or more conditions, and

the certification information generation unit

generates, for each of the plurality of conditional expressions, a proof based on the plurality of conditional expressions selected by the conditional expression generation unit as the certification information.

(6)

The generation device according to (5), in which

the conditional expression generation unit

selects, in response to the condition included in the conditional expression changed, a conditional expression including the condition to be changed from among pre-generated conditional expressions, and

the certification information generation unit

regenerates and updates a proof based on the conditional expression selected by the conditional expression generation unit.

(7)

The generation device according to (5), wherein

the conditional expression generation unit

selects, in response to the condition included in the conditional expression changed, a conditional expression including the condition to be changed from among pre-generated conditional expressions, and

the certification information generation unit

regenerates and updates a proof based on the conditional expression selected by the conditional expression generation unit.

(8)

The generation device according to (5), wherein

the pre-generated conditional expressions

are generated in advance on the basis of a request history of an information user who requests confidential information.

(9)

A generation method comprising:

by a computer generating certification information used for verification using zero-knowledge proof,

generating a plurality of conditional expressions that define confidential information under one or more conditions for different conditions; and

generating as the certification information, a plurality of proofs based on each of the plurality of conditional expressions.

(10)

A verification device for performing verification using zero-knowledge proof, including:

an acquisition unit that acquires, as certification information used for verification using zero-knowledge proof, a proof generated using confidential information that matches a specified condition from a plurality of proofs based on a plurality of conditional expressions that includes one or more conditions for defining confidential information and are generated for different conditions; and

a verification unit that verifies the proof acquired by the acquisition unit and executes a condition determination as to whether or not the confidential information that matches the specified condition can be acquired.

### REFERENCE SIGNS LIST

1 INFORMATION PROCESSING SYSTEM
10 USER TERMINAL
11 COMMUNICATION UNIT
12 INPUT UNIT
13 OUTPUT UNIT
14 IMAGE-CAPTURING UNIT
15 POSITIONING UNIT
16 DETECTION UNIT
17 STORAGE UNIT
18 CONTROL UNIT
20 INFORMATION BANK DEVICE
21 COMMUNICATION UNIT
22 STORAGE UNIT
22a PERSONAL INFORMATION STORAGE UNIT
22b CERTIFICATION INFORMATION STORAGE UNIT
23 CONTROL UNIT
23a SETUP PROCESSING UNIT
23b GENERATION UNIT
23c PROVIDING UNIT
23d REGENERATION UNIT
30 INFORMATION USER DEVICE
31 COMMUNICATION UNIT
32 INPUT UNIT
33 OUTPUT UNIT
34 STORAGE UNIT
35 CONTROL UNIT
35a ACQUISITION UNIT
35b VERIFICATION UNIT

1. A generation device for generating certification information used for verification using zero-knowledge proof, comprising:
a conditional expression generation unit that generates, for different conditions, a plurality of conditional expressions that define confidential information under one or more conditions; and
a certification information generation unit that generates, as the certification information, a plurality of proofs based on each of the plurality of conditional expressions.

2. The generation device according to claim 1, wherein
the conditional expression generation unit
adds, to each of the plurality of conditional expressions generated, information indicating that confidential information defined by each of the plurality of conditional expressions belongs to a specific individual.

3. The generation device according to claim 2, wherein
the certification information generation unit
regenerates and updates, in response to the confidential information defined by the conditional expression changed, a proof based on a conditional expression that defines confidential information corresponding to the change.

4. The generation device according to claim 2, wherein
the certification information generation unit
regenerates and updates, in response to the condition included in the conditional expression changed, a proof based on a conditional expression including the condition to be changed.

5. The generation device according to claim 1, wherein
the conditional expression generation unit
selects a plurality of conditional expressions that defines confidential information from among a plurality of pre-generated conditional expressions that is generated in advance as the plurality of conditional expressions for defining various types of confidential information under one or more conditions, and
the certification information generation unit
generates, for each of the plurality of conditional expressions, a proof based on the conditional expressions selected by the conditional expression generation unit as the certification information.

6. The generation device according to claim 5, wherein
the conditional expression generation unit
selects, in response to the confidential information defined by the conditional expression changed, a conditional expression that defines confidential information corresponding to the change from among pre-generated conditional expressions, and
the certification information generation unit
regenerates and updates a proof based on the conditional expression selected by the conditional expression generation unit.

7. The generation device according to claim 5, wherein
the conditional expression generation unit
selects, in response to the condition included in the conditional expression changed, a conditional expression including the condition to be changed from among pre-generated conditional expressions, and
the certification information generation unit
regenerates and updates a proof based on the conditional expression selected by the conditional expression generation unit.

8. The generation device according to claim 5, wherein
the pre-generated conditional expressions
are generated in advance on the basis of a request history of an information user who requests confidential information.

9. A generation method comprising:
by a computer generating certification information used for verification using zero-knowledge proof,
generating a plurality of conditional expressions that define confidential information under one or more conditions for different conditions; and
generating as the certification information, a plurality of proofs based on each of the plurality of conditional expressions.

10. A verification device for performing verification using zero-knowledge proof, comprising:
as certification information used for verification using zero-knowledge proof,
an acquisition unit that acquires a proof generated using confidential information that matches a specified condition from a plurality of proofs based on a plurality of conditional expressions that is generated for different conditions to define confidential information under one or more conditions; and
a verification unit that verifies the proof acquired by the acquisition unit and executes a condition determination as to whether or not the confidential information that matches the specified condition can be acquired.
